(19) United States
(12) Patent Application Publication
(10) Pub. No.: US 2023/0292672 A1
(43) Pub. Date: Sep. 21, 2023

(54) METHODS AND SYSTEMS FOR PLASMA STIMULATION OF PLANT GROWTH

(71) Applicant: Archer Laboratories, LLC, Albuquerque, NM (US)

(72) Inventors: John Samuel Thurman, Albuquerque, NM (US); Haynes Wood, Corrales, NM (US); Rajat Raj Adhikari, Albuquerque, NM (US)

(21) Appl. No.: 18/123,076

(22) Filed: Mar. 17, 2023

Related U.S. Application Data
(60) Provisional application No. 63/321,623, filed on Mar. 18, 2022.

(51) Int. Cl. A01G 7/04; H05H 1/24; H01F 27/28

(52) U.S. Cl. CPC A01G 7/04; H05H 1/24; H01F 27/28; H05H 2245/40

(57) ABSTRACT

Systems and methods for generating plasma to stimulate plant growth comprise a high voltage generation circuit comprising a mains power input, a high power mosfet and insulated-gate bipolar transistor, and a trigger circuit; and a plasma emitter plant applicator comprising an applicator body, a plasma applicator shield, and two plasma activator electrodes configured to generate an electric field therebetween.

### CROSS REFERENCE TO RELATED APPLICATIONS

This patent application claims the priority and benefit under 35 U.S.C. § 119(e) of U.S. Provisional Patent Application Ser. No. 63/321,623 filed Mar. 18, 2022, entitled “METHODS AND SYSTEMS FOR PLASMA STIMULATION OF PLANT GROWTH.” U.S. Provisional Patent Application Ser. No. 63/321,623 is herein incorporated by reference in its entirety.

### TECHNICAL FIELD

Embodiments are generally related to the field of plasma generation. Embodiments are also related to the field of botany. Embodiments are also related to the field of plant growth. Embodiments are further related to the field of plasma treatments of plants. Embodiments are also related to systems and methods for generating plasma plumes and applying the plasma to plant roots to stimulate plant growth.

### BACKGROUND

Plant growth is the seed of humanity. The ability to cultivate flora is a critical cog in the functioning of society. Given the expanding demands of humans for plant based food, drugs, and materials, there is an ever present need to find more efficient means for fostering plant growth.

Numerous attempts have been made, some successful, to increase the growth rate for plants. The benefits of these techniques are obvious. If plants can be raised from seed to root to bloom more quickly, the production cycle can be reduced which means more plants can be grown in less time. Given the demand for plants this remains a field where even small advances can offer massively valuable results.

There is an ever-growing need for efficient and inexpensive methods and systems for improving plant growth. As such, the embodiments disclosed herein describe such a system that employs plasma as a means for stimulating plant growth as detailed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for generating plasma.

It is another aspect of the disclosed embodiments to provide a method, system, and apparatus for controlling a generated plasma.

It is another aspect of the disclosed embodiments to provide a method, system, and apparatus for generating and controlling plasma for application to seeds or plants.

It is another aspect of the disclosed embodiments to provide a method, system, and apparatus for bulk plasma treatment for agricultural purposes.

The aforementioned aspects and other objectives and advantages can now be achieved as described herein. In an exemplary embodiment, a high voltage pulsed power supply can be connected to a treatment apparatus. The treatment apparatus is filled with electric field enhancement media and the agriculture products selected for treatment; i.e., cuttings, seeds, bulbs, rhizomes, etc. Additionally, gases like helium, argon, air, etc. can be flowed across the media to enhance discharge.

In an embodiment, a system comprises a high voltage generation circuit and a plasma emitter plant applicator, wherein the plasma emitter plant applicator is configured to treat plants with plasma. In an embodiment, the high voltage generation circuit comprises a mains power input, a high power mosfet and insulated-gate bipolar transistor and a trigger circuit. In an embodiment, the high voltage generation circuit further comprises a rectifier circuit. In an embodiment, the system comprises a transformer operably connected to the plasma emitter plant applicator. In an embodiment, the transformer further comprises a first high voltage transformer coil operably connected to the high power mosfet and insulated-gate bipolar transistor and a second high voltage transformer coil operably connected to the plasma emitter plant applicator. In an embodiment, the plasma emitter plant applicator further comprises an applicator body, a plasma applicator shield, and two plasma activator electrodes. In an embodiment, the two plasma activator electrodes are inserted in plasma activator slots in the applicator body. In an embodiment, the plasma applicator shield further comprises at least two aligned vias. In an embodiment, the system further comprises a dispenser tube formed on the applicator body.

In an embodiment a system comprises a high voltage generation circuit comprising a mains power input, a high power mosfet and insulated-gate bipolar transistor, and a trigger circuit; and a plasma emitter plant applicator comprising an applicator body, a plasma applicator shield, and two plasma activator electrodes configured to generate an electric field therebetween, wherein the plasma emitter plant applicator is configured to treat plants with plasma. In an embodiment, the high voltage generation circuit further comprises a rectifier circuit. In an embodiment, at transformer comprises a first high voltage transformer coil operably connected to the high power mosfet and insulated-gate bipolar transistor and a second high voltage transformer coil operably connected to the plasma emitter plant applicator. In an embodiment, the two plasma activator electrodes are inserted in plasma activator slots in the applicator body. In an embodiment, the plasma applicator shield further comprises at least two aligned vias. In an embodiment, the system comprises a dispenser tube formed on the applicator body.

In an embodiment a method for stimulating plant growth comprises generating a plasma in a plasma applicator system and applying the plasma to a plant. In an embodiment, applying the plasma to a plant comprises applying the plasma to at least one of: a plant seed, a plant root, and plant cuttings. In an embodiment, applying the plasma to a plant comprises applying the plasma to soil surrounding the plant. In an embodiment, the method further comprises configuring a plasma applicator system. In an embodiment of the method, the plasma applicator system comprises a high voltage generation circuit comprising a mains power input, a high power mosfet and insulated-gate bipolar transistor, and a trigger circuit; and a plasma emitter plant applicator comprising: an applicator body, a plasma applicator shield, and two plasma activator electrodes configured to generate an electric field therebetween wherein the plasma emitter plant applicator is configured to treat plants with plasma.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an embodiment;

FIG. 4 depicts a plasma treatment system, in accordance with the disclosed embodiments;

FIG. 5 depicts a plant cutting assembly, in accordance with the disclosed embodiments;

FIG. 6A depicts high voltage transformer coils in accordance with the disclosed embodiments;

FIG. 6B depicts high voltage transformer coils in accordance with the disclosed embodiments;

FIG. 7A depicts a top perspective view of a plasma applicator body, in accordance with the disclosed embodiments;

FIG. 7B depicts a bottom perspective view of a plasma applicator body, in accordance with the disclosed embodiments;

FIG. 7C depicts a top plan view of a plasma applicator body, in accordance with the disclosed embodiments;

FIG. 8A depicts a top view of a plasma applicator safety shield, in accordance with the disclosed embodiments;

FIG. 8B depicts a top perspective view of a plasma applicator safety shield, in accordance with the disclosed embodiments;

FIG. 9 depicts a plasma applicator assembly, in accordance with the disclosed embodiments;

FIG. 10 depicts a plasma activator high voltage electrode, in accordance with the disclosed embodiments;

FIG. 11 depicts a plasma applicator assembly, in accordance with the disclosed embodiments; and

FIG. 12 depicts steps associated with a method for treating plants with plasma, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “microwave” as used herein, refers to a particular radiofrequency wave generating mechanism, but does not exclude any other radiofrequency wave generating systems.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

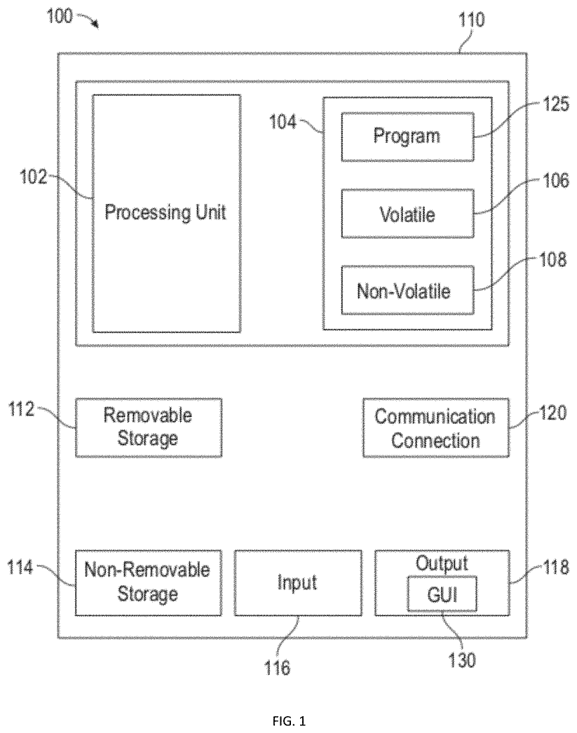

FIGS. 1-3 are provided as exemplary diagrams of data-processing environments in which embodiments disclosed herein may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108.

Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

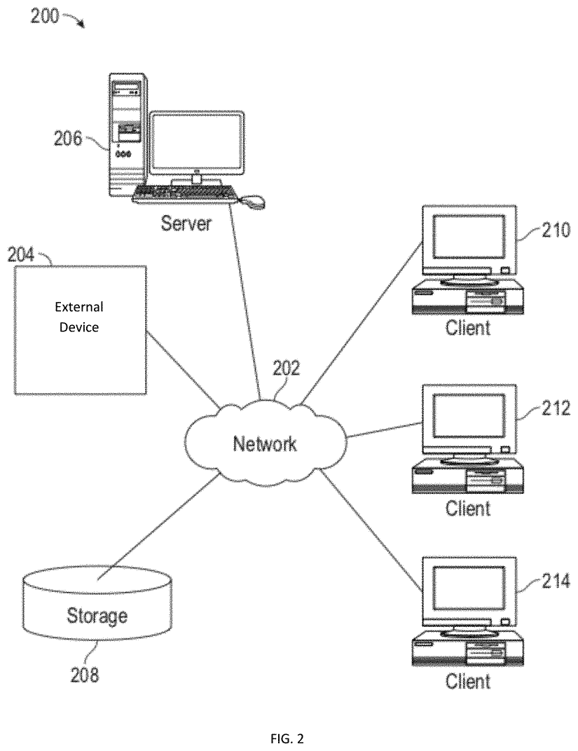

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present embodiments may be implemented. Network data-processing system 200 is a network of computers or other such devices such as mobile phones, smartphones, sensors, detection devices, controllers and the like in which embodiments may be implemented. Note that the system 200 can be implemented in the context of a software module such as program module 125. The system 200 includes a network 202 in communication with one or more clients 210, 212, and 214. Network 202 may also be in communication with one or more devices 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as a controller, actuator, magnetron, RF device, control system or other such device 204, and a memory storage unit such as, for example, memory or database 208. It should be understood that device 204 may be embodied as a detector device, microcontroller, controller, receiver, transceiver, or other such device.

In the depicted example, external device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and external device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments disclosed herein.

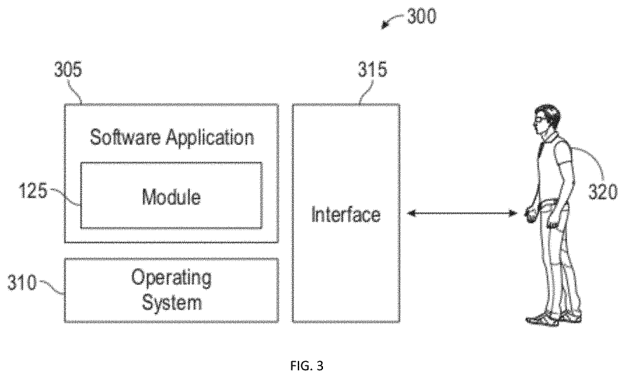

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, 3D printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

The embodiments disclosed herein make use of a versatile system that generates a plasma plume for various applications. The embodiments include a high voltage pulsed power supply connected to a treatment apparatus. This treatment apparatus is filled with electric field enhancement media and the agriculture products selected for treatment; i.e., cuttings, seeds, bulbs, rhizomes, etc. Additionally, gases like helium, argon, air, etc. can be flowed across the media to enhance discharge. This is a non GMO, organic process.

In certain embodiments, the disclosed systems and methods are configured for plasma treatment of agriculture products such as plant seeds, grape vines, and rhizomes. Plasma treatment of plant cuttings can include treatment in packed bed reactors. Additionally, the specific layout of the treatment system includes geometrical structures which help direct the plasma formation in the preferred volumes, specifically that of the plant stems.

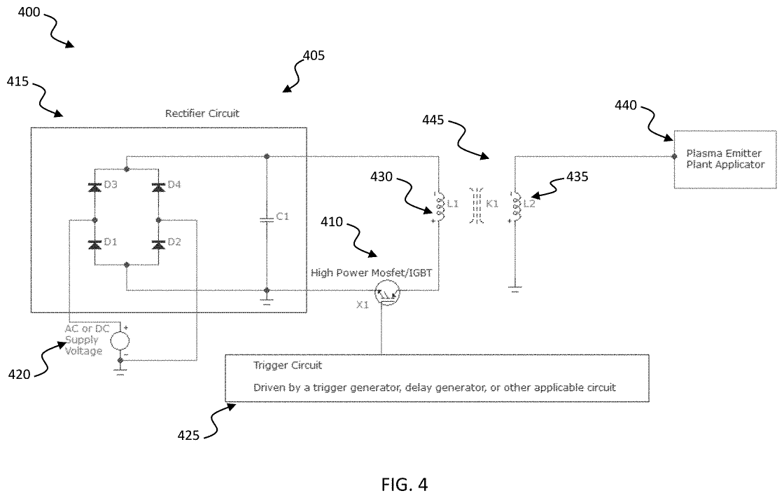

FIG. 4 illustrates a circuit diagram for a treatment system 400 in accordance with the disclosed embodiments. The circuit 400 can include a high voltage generation circuit 405 that can be configured with parallel MOSFET and/or insulated-gate bipolar transistor (IGBT) 410 for higher average power. The circuit 400 can be connected to a computer system, as illustrated in FIGS. 1-3 for control of the associated plasm emission.

The circuit 400 can include a rectifier circuit 415 with an AC or DC supply voltage provided via a mains power input 420. A trigger circuit 425 can be used as a trigger. The trigger circuit 425 can be driven by a trigger generator, delay generator, or other such circuit. A transformer 445 comprises an inductor 430 used to drive a second inductor 435 operably connected to the plasma emitter plant applicator 440 as illustrated.

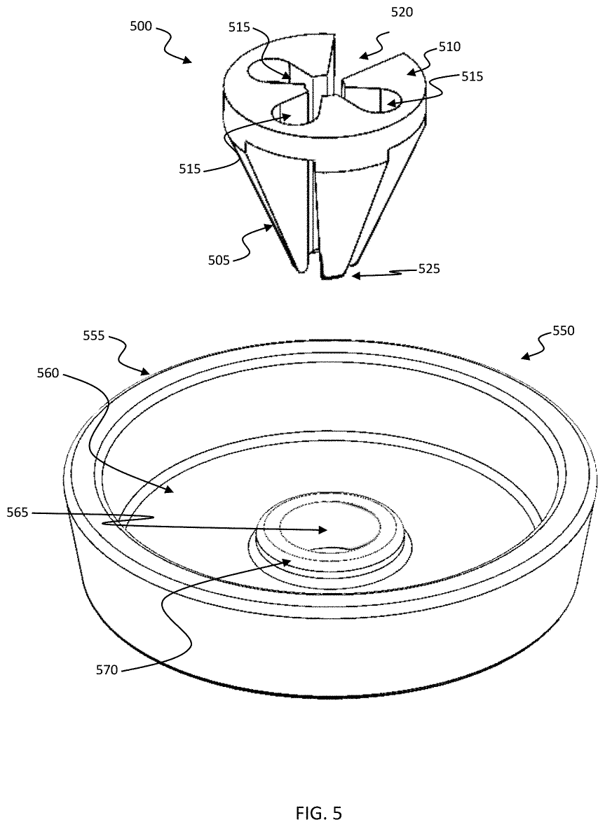

FIG. 5 illustrates a plant cutting clamp 500 and plant cutting boat 550. The plant cutting clamp 500 includes arms 505, connected to top surface 510. The top surface 510 has cutouts 515, along with gap 520. The cutting clamp 500 is tapered from the top surface 510 along the arms 505 to the distal end 525.

The distal end 525 of the arms 505 are configured to interface with the plant cutting boat 550. The plant cutting boat 550 includes an outer rim 555 and pan 560, with an inner ring 565. The inner ring includes an inner lip 570. The arms 505 of the plant cutting clamp 500 can be inserted into the ring 565 of the plant cutting boat 550 in order to cut or trim plants as necessary.

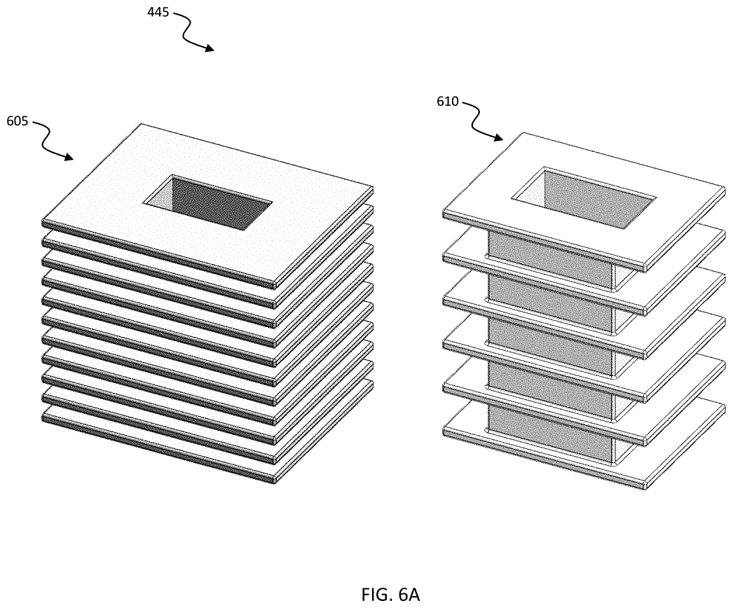

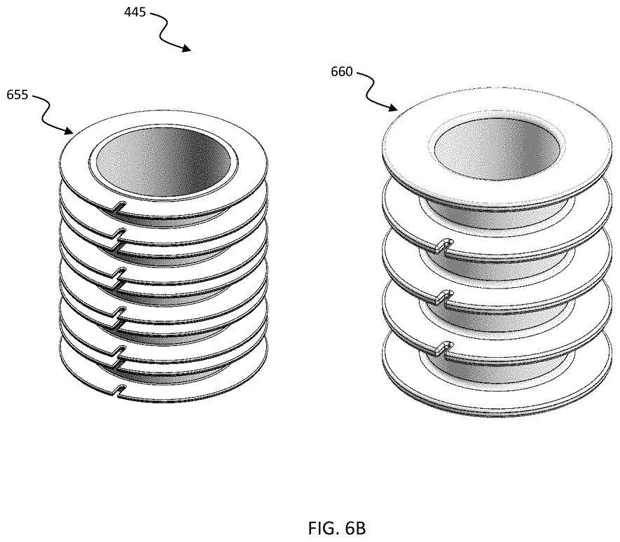

FIG. 6A illustrates an exemplary embodiment of a high voltage transformer 445 in accordance with the disclosed embodiments. The transformer 445 comprises a first high voltage transformer coil 605 and a second high voltage transformer coil 610. The first high voltage transformer coil 605 is the coil in a transformer that is energized by the source. The second coil 610 is the coil connected to the load.

FIG. 6B illustrates another exemplary embodiment of a high voltage transformer 445 in accordance with the disclosed embodiments. The transformer 445 comprises a first high voltage transformer coil 655 and a second high voltage transformer coil 660. The first high voltage transformer coil 655 is the coil in a transformer that is energized by the source. The second coil 660 is the coil connected to the load.

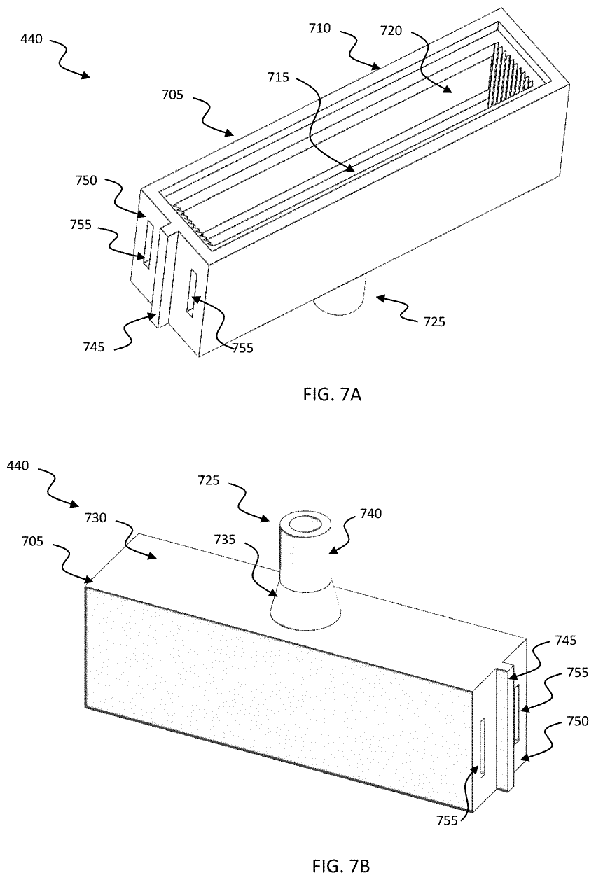

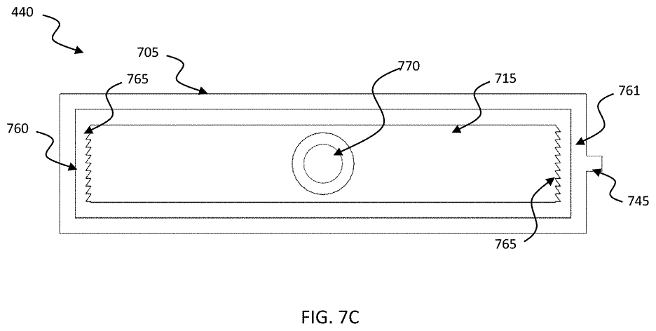

FIG. 7A and FIG. 7B illustrate a plasma applicator 440 in accordance with the disclosed embodiments. The plasma applicator 440 comprises an applicator body 705 configured as a rectangular structure 710 with a base 715 thereby forming an inner trough 720. A conduit 725 is configured on the exterior side 730 of the base 715. The conduit 725 comprises a nozzle base 735 and dispenser tube 740, and is configured to serve as the applicator for plasma.

The body 705 includes a strut 745 on the side 750. The side 750 further includes activator electrode slots 755 configured to accept plasma activator electrodes as further detailed herein. Plasma is generated by creating an electric field between plasma activator high voltage electrode 1000. Gas can be introduced to the electric field inside the applicator body 705 where plasma is generated.

FIG. 7C illustrates a top view of the plasma applicator 440. As illustrated, the internal side wall 760 and second internal side wall 761 can be textured with texturing 765. The base 715 can include an opening 770 connected to the nozzle base 735, on the exterior side of the base 715.

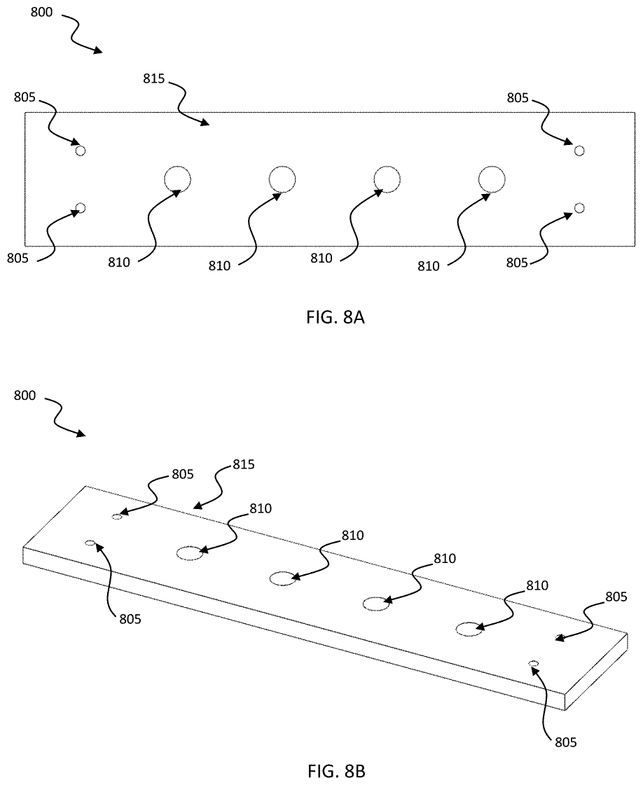

FIG. 8A and FIG. 8B illustrate a plasma applicator shield 800 associated with a plasma applicator 440. The plasma applicator shield 800 comprises a plate 815 configured to fit over the inner trough 720 to prevent undesirable plasma application. The plasma applicator shield 800 can include mounting holes 805, as well as a series of vias 810 aligned along the plasma applicator shield 800.

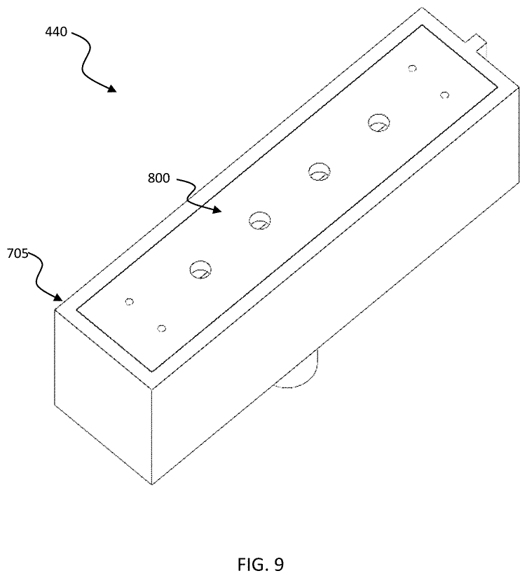

FIG. 9 illustrates the plasma applicator 440 assembly including the applicator body 705 with the plasma applicator shielding 800 installed.

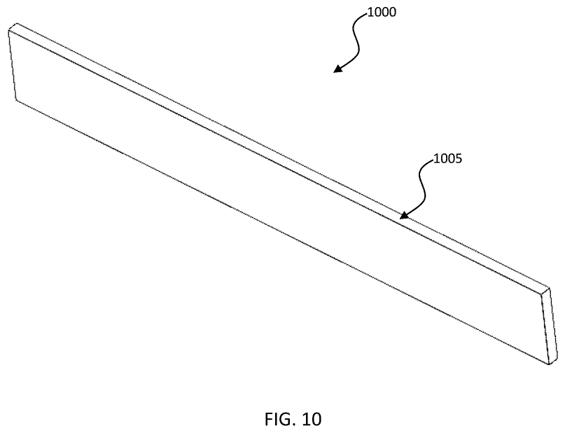

FIG. 10 illustrates a plasma activator high voltage electrode 1000. The plasma activator high voltage electrode 1000, comprises a plate body 1005 configured for installation in the plasma applicator body 705.

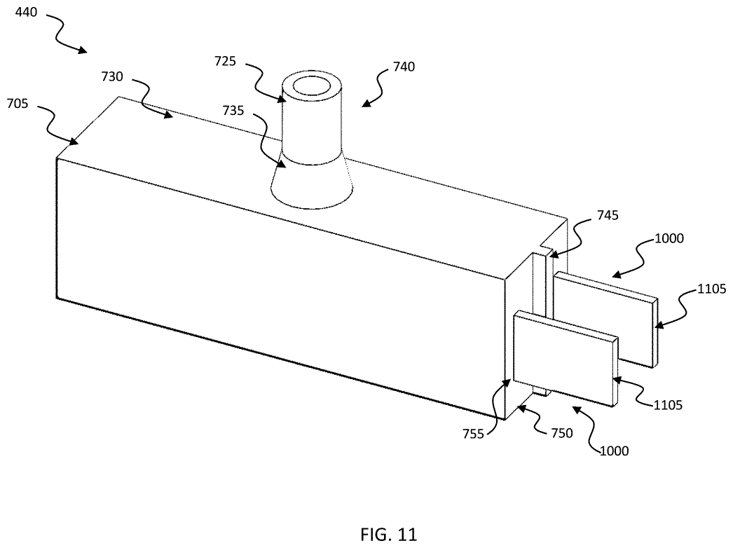

FIG. 11 illustrates the assembled plasma applicator 440 including the installation of the plasma activator electrodes 800 installed in the plasma activator electrode slots 755. The ends 1105 of the electrodes 800 can extend out of the electrode slots as serve as connection points.

The plasma applicator 440 is configured to produce plasma, which can be applied to organic matter, such as soil or plant roots in order to stimulate plant growth.

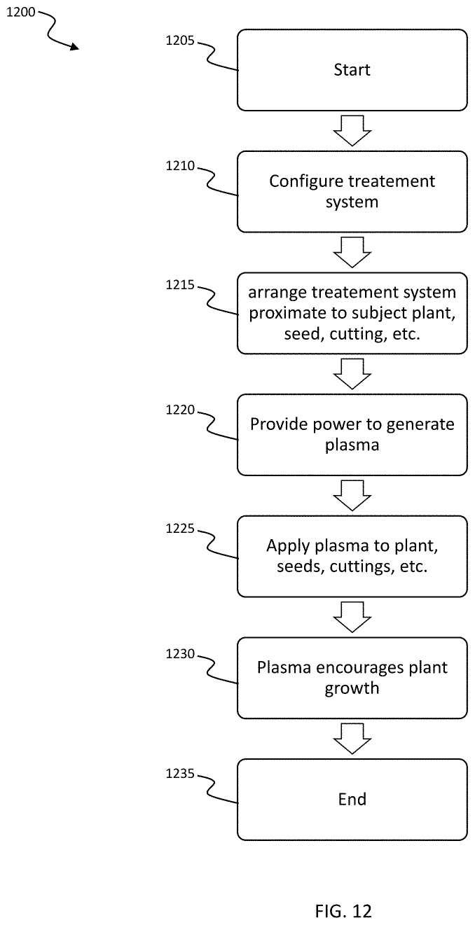

FIG. 12 illustrates steps in a method 1200 for stimulating plant growth. The method starts at step 1205.

At step 1210 a treatment system such as treatment system 400 as disclosed herein can be configured. The system can include the circuitry illustrated in FIG. 4 as well as a plasma emitter 440, as illustrated in FIGS. 5-11, which is configured to generate and distribute plasma. In exemplary embodiments, the system 400 can be configured proximate to subject plant, seeds, cuttings, etc. as shown at step 1215.

Next, at step 1220 power can be provided to the system in order to generate plasm. In general, the plasma is generated by creating an electric field between plasma activator high voltage electrode 1000. Plasma is generated in the electric field.

At step 1225 The plasma can be directed to the subject plant, seeds, roots, plant cuttings, surrounding soil or the like. The administration of plasma to the subject plant encourages plant growth as illustrated at step 1230. and the method ends at step 1235.

The embodiments are configured to treat any plant cuttings, to include those used in grafting and cloning. These cuttings can be of stems, leaves, or other similar geometries. In certain aspects time to root, sprout, or germinate after treatment is reduced by up to 26 days from an expected maximum of 28 days for root propagation to 2 days in the case of clippings. Embodiments also yield an average reduction in root propagation time of over 50%. The root mass and length can also be increased using the disclosed systems. These effects can reduce the amount of water and fertilizer needed to produce crops, reduce cycle time of crops, allow for more time for crop maturity, improve crop yield, and increase global food security.

The embodiments can run at ambient temperatures and pressures, requiring no extreme modifications of the environment to work. This system utilizes no chemical treatments or specialized gasses. As such, it can be used with organic certified agricultural products without impacting that certification. There is no evidence of any genetic effects, which makes it compatible with non-gmo products, and cloning operations where genetic diversity is not desired.

The system only requires electrical input to work, with no special gasses or chemicals needed. As such, the system can be configured as a completely renewable treatment, reducing the carbon footprint of the agricultural industry, allowing treatments to continue during supply chain issues, and allowing remote treatment in areas that are not fully developed.

Applications include use in industries such as tree grafting, fruit, vegetable, and herb propagation, expansion of growing zones for different varieties of plants, green house, indoor, and hydroponic farming, and any other area where improved germination time and root growth would be advantageous.

Based on the foregoing, it can be appreciated that a number of embodiments, preferred and alternative, are disclosed herein. For example, in an embodiment, a system comprises a high voltage generation circuit and a plasma emitter plant applicator, wherein the plasma emitter plant applicator is configured to treat plants with plasma.

In an embodiment, the high voltage generation circuit comprises a mains power input, a high power mosfet and insulated-gate bipolar transistor and a trigger circuit. In an embodiment, the high voltage generation circuit further comprises a rectifier circuit. In an embodiment, the system comprises a transformer operably connected to the plasma emitter plant applicator. In an embodiment, the transformer further comprises a first high voltage transformer coil operably connected to the high power mosfet and insulated-gate bipolar transistor and a second high voltage transformer coil operably connected to the plasma emitter plant applicator.

In an embodiment, the plasma emitter plant applicator further comprises an applicator body, a plasma applicator shield, and two plasma activator electrodes. In an embodiment, the two plasma activator electrodes are inserted in plasma activator slots in the applicator body. In an embodiment, the plasma applicator shield further comprises at least two aligned vias. In an embodiment, the system further comprises a dispenser tube formed on the applicator body.

In an embodiment a system comprises a high voltage generation circuit comprising a mains power input, a high power mosfet and insulated-gate bipolar transistor, and a trigger circuit; and a plasma emitter plant applicator comprising an applicator body, a plasma applicator shield, and two plasma activator electrodes configured to generate an electric field therebetween, wherein the plasma emitter plant applicator is configured to treat plants with plasma.

In an embodiment, the high voltage generation circuit further comprises a rectifier circuit. In an embodiment, a transformer comprises a first high voltage transformer coil operably connected to the high power mosfet and insulated-gate bipolar transistor and a second high voltage transformer coil operably connected to the plasma emitter plant applicator.

In an embodiment, the two plasma activator electrodes are inserted in plasma activator slots in the applicator body. In an embodiment, the plasma applicator shield further comprises at least two aligned vias. In an embodiment, the system comprises a dispenser tube formed on the applicator body.

In an embodiment a method for stimulating plant growth comprises generating a plasma in a plasma applicator system and applying the plasma to a plant.

In an embodiment, applying the plasma to a plant comprises applying the plasma to at least one of: a plant seed, a plant root, and plant cuttings. In an embodiment, applying the plasma to a plant comprises applying the plasma to soil surrounding the plant. In an embodiment, the method further comprises configuring a plasma applicator system.

In an embodiment of the method, the plasma applicator system comprises a high voltage generation circuit comprising a mains power input, a high power mosfet and insulated-gate bipolar transistor, and a trigger circuit; and a plasma emitter plant applicator comprising: an applicator body, a plasma applicator shield, and two plasma activator electrodes configured to generate an electric field therebetween wherein the plasma emitter plant applicator is configured to treat plants with plasma.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a high voltage generation circuit; and
a plasma emitter plant applicator, wherein the plasma emitter plant applicator is configured to treat plants with plasma.

2. The system of claim 1 wherein the high voltage generation circuit comprises:
a mains power input;
a high power mosfet and insulated-gate bipolar transistor; and
a trigger circuit.

3. The system of claim 2 wherein the high voltage generation circuit further comprises:
a rectifier circuit.

4. The system of claim 1 further comprising:
a transformer operably connected to the plasma emitter plant applicator.

5. The system of claim 4 wherein the transformer further comprises:
a first high voltage transformer coil operably connected to the high power mosfet and insulated-gate bipolar transistor; and
a second high voltage transformer coil operably connected to the plasma emitter plant applicator.

6. The system of claim 1 wherein the plasma emitter plant applicator further comprises:
an applicator body;
a plasma applicator shield; and
two plasma activator electrodes.

7. The system of claim 6 wherein the two plasma activator electrodes are inserted in plasma activator slots in the applicator body.

8. The system of claim 6 wherein the plasma applicator shield further comprises:
at least two aligned vias.

9. The system of claim 6 further comprising:
a dispenser tube formed on the applicator body.

10. A system comprising:
a high voltage generation circuit comprising:
a mains power input;
a high power mosfet and insulated-gate bipolar transistor; and
a trigger circuit; and
a plasma emitter plant applicator comprising:
an applicator body;
a plasma applicator shield; and
two plasma activator electrodes configured to generate an electric field therebetween;
wherein the plasma emitter plant applicator is configured to treat plants with plasma.

11. The system of claim 10 wherein the high voltage generation circuit further comprises:
a rectifier circuit.

12. The system of claim 10 further comprising:
a transformer comprising:
a first high voltage transformer coil operably connected to the high power mosfet and insulated-gate bipolar transistor; and
a second high voltage transformer coil operably connected to the plasma emitter plant applicator.

13. The system of claim 10 wherein the two plasma activator electrodes are inserted in plasma activator slots in the applicator body.

14. The system of claim 13 wherein the plasma applicator shield further comprises:
at least two aligned vias.

15. The system of claim 10 further comprising:
a dispenser tube formed on the applicator body.

16. A method for stimulating plant growth comprising:
generating a plasma in a plasma applicator system; and
applying the plasma to a plant.

17. The method of claim 16 where applying the plasma to a plant comprises:
applying the plasma to at least one of:
a plant seed;
a plant root;
plant cuttings.

18. The method of claim 16 where applying the plasma to a plant comprises:
applying the plasma to soil surrounding the plant.

19. The method of claim 16 further comprising:
configuring a plasma applicator system.

20. The method of claim 19 wherein the plasma applicator system comprises:
a high voltage generation circuit comprising:
a mains power input;
a high power mosfet and insulated-gate bipolar transistor; and
a trigger circuit; and
a plasma emitter plant applicator comprising:
an applicator body;
a plasma applicator shield; and
two plasma activator electrodes configured to generate an electric field therebetween,
wherein the plasma emitter plant applicator is configured to treat plants with plasma.
